(19) United States
(12) Patent Application Publication
(10) Pub. No.: US 2013/0041726 A1
(43) Pub. Date: Feb. 14, 2013

(54) Methods and Systems for Identifying Demand for, and Negotiating Discounted Prices of, Goods and Services

(71) Applicant: Carl Randlett Hall, Boston, MA (US)

(72) Inventor: Carl Randlett Hall, Boston, MA (US)

(21) Appl. No.: 13/567,738

(22) Filed: Aug. 6, 2012

Related U.S. Application Data
(60) Provisional application No. 61/522,916, filed on Aug. 12, 2011.

(51) Int. Cl. G06Q 30/02

(52) U.S. Cl. 705/14.1

(57) ABSTRACT

A method includes receiving, by a first computing device, from a second computing device, funding for use in purchasing a type of good or service. The method includes determining, by the first computing device, a level of interest in the type of good or service by a user of the second computing device, based on an amount of the funding. The method includes determining, by the first computing device, that a plurality of users has provided funding for use in purchasing items having the type of good or service. The method includes negotiating, by the first computing device, with a retail computing device for a discounted price for items having the type of good or service. The method includes making, by the first computing device, an item having the type of good or service available for purchase by each of the plurality of users at the negotiated, discounted price.

### CROSS-REFERENCE TO RELATED APPLICATIONS

This application claims priority from U.S. Provisional Patent Application Ser. No. 61/522,916, filed on Aug. 12, 2011, entitled “Methods and Systems for Identifying Demand for, and Negotiating Discounted Prices of, Goods and Services” which is hereby incorporated by reference.

### BACKGROUND

The disclosure relates to methods and systems for purchasing goods and services. More particularly, the methods and systems described herein relate to identifying demand for, and negotiating discounted prices of, goods and services.

Conventional systems for negotiating discounted prices for goods and services do not typically gauge consumer interest in the goods and services before beginning the negotiation process. Typically, before informing one or more consumers of an opportunity for a discounted price, an entity offering to negotiate a discounted price on behalf of the one or more consumers reaches out to a retailer of a good or service and determines how much of a discount the retailer would be willing to offer and how many consumers the retailer would need to be guaranteed before being willing to offer the discount; such systems do not conventionally gauge consumer interest before negotiating the discount. Further, such conventional systems do not typically offer consumers a means with which to set aside resources for making a purchase once a discounted price is negotiated.

### BRIEF SUMMARY

In one aspect, a method described herein provides functionality for identifying demand for, and negotiating discounted prices of, goods and services. The method includes receiving, by a first computing device, from a second computing device, funding for use in purchasing a type of good or service. The method includes determining, by the first computing device, a level of interest in the type of good or service by a user of the second computing device, based on an amount of the funding. The method includes determining, by the first computing device, that a plurality of users has provided funding for use in purchasing items having the type of good or service. The method includes negotiating, by the first computing device, with a retail computing device for a discounted price for items having the type of good or service. The method includes making, by the first computing device, an item having the type of good or service available for purchase by each of the plurality of users at the negotiated, discounted price.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A-1C are block diagrams depicting embodiments of computers useful in connection with the methods and systems described herein;

FIG. 2 is a block diagram depicting an embodiment of a system for identifying demand for, and negotiating discounted prices of, goods and services;

FIG. 3 is a flow diagram depicting an embodiment of a method for identifying demand for, and negotiating discounted prices of, goods and services; and

FIG. 4 is a flow diagram depicting an embodiment of another method for identifying demand for, and negotiating discounted prices of, goods and services.

### DETAILED DESCRIPTION

In some embodiments of the methods and systems described herein, functionality is provided for identifying demand for, and negotiating discounted prices of, goods and services. Before describing methods and systems for identifying demand for and negotiating discounted prices of goods and services in detail, a description is provided of a network in which such methods and systems may be implemented.

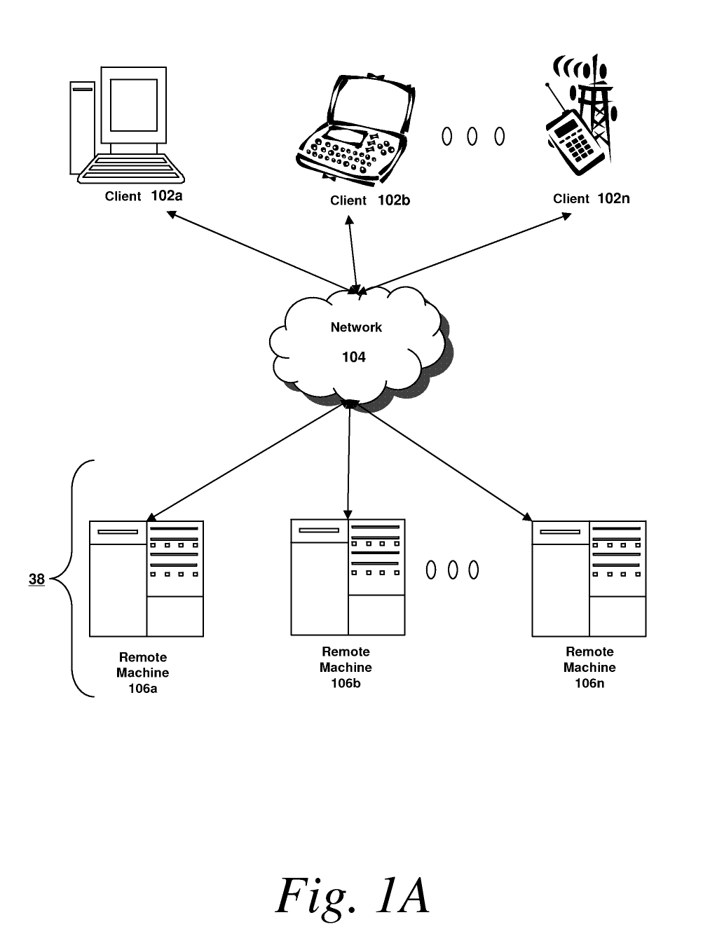

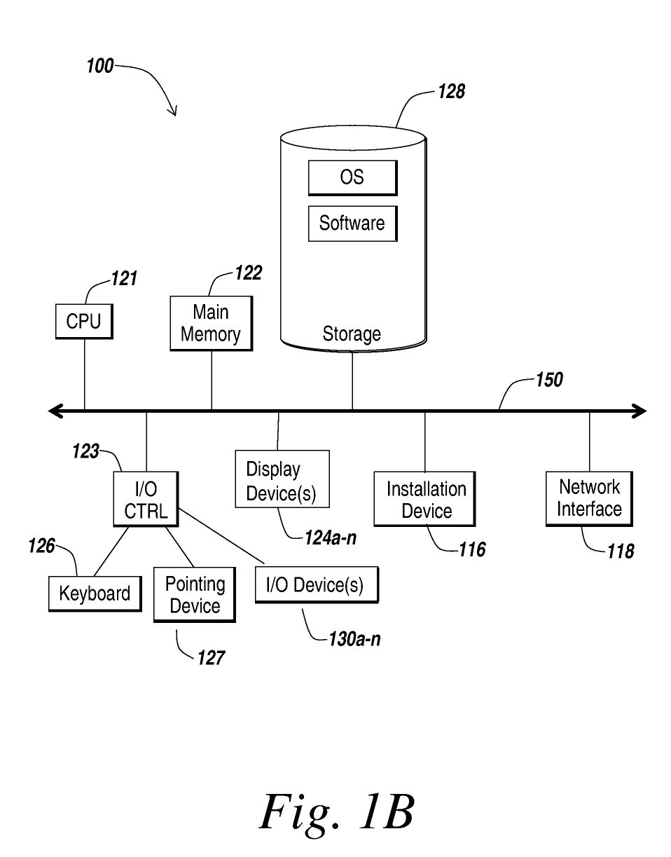

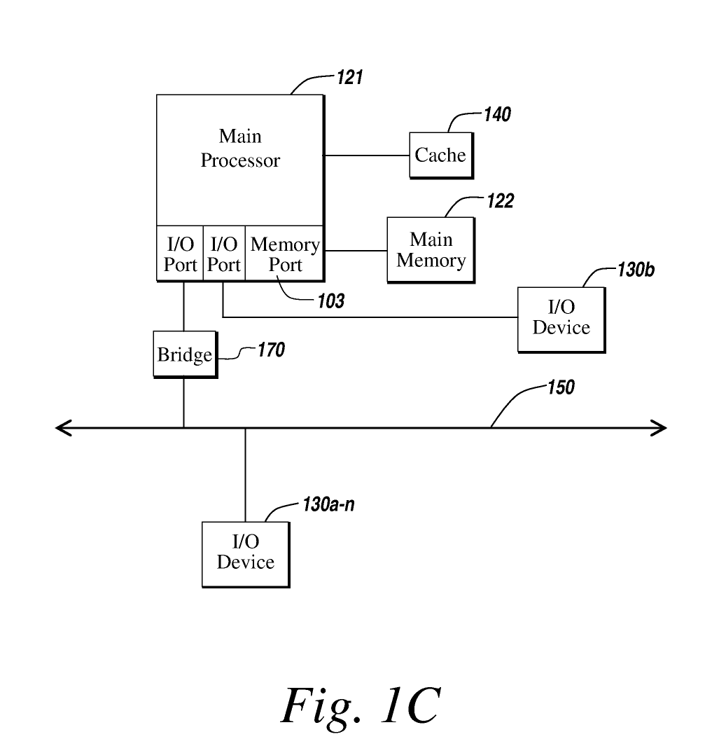

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106, computing device(s) 106, or remote machine(s) 106) via one or more networks 104.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network 104 may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In one embodiment, a computing device 106 provides the functionality of a web server. In some embodiments, a web server 106 comprises an open-source web server, such as the APACHE servers maintained by the Apache Software Foundation of Delaware. In other embodiments, the web server 106 executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif. Furthermore, the computing device 106 may be provided as a blade server executing one or more virtual machines.

A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In some embodiments, the system may include multiple, logically-grouped remote machines 106. In one of these embodiments, the logical group of remote machines may be referred to as a server farm 38. In another of these embodiments, the server farm 38 may be administered as a single entity.

The client 102 and the computing device 106 may be deployed as, and/or executed on, any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more input/output (I/O) devices 130a-130n (generally referred to using reference numeral 130). The storage device 128 may include, without limitation, an operating system and software. As shown in FIG. 1C, each computing device 100 may also include additional optional elements, such as a memory port 103, a bridge 170, one or more I/O devices 130, and a cache memory 140 in communication with the central processing unit 121.

The central processing unit 121 is any logic circuitry that responds to, and processes instructions fetched from, the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local buses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, a computer 100 connects to a second computer 100′ on a network using any one of a number of well-known protocols from the GSM or CDMA families, such as W-CDMA. These protocols support commercial wireless communication services and W-CDMA, in particular is the underlying protocol supporting i-Mode and mMode services offered by NTT DoCoMo.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7 and WINDOWS VISTA, all of which are manufactured by Microsoft Corporation of Redmond, Wash.; MAC OS manufactured by Apple Inc., of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif., USA; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc. of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices manufactured by Apple Inc.; the PlayBook, manufactured by Research in Motion; the Cruz line of devices manufactured by Velocity Micro, Inc., of Richmond, Va.; the Folio and Thrive line of devices manufactured by Toshiba America Information Systems, Inc., of Irvine, Calif.; the Galaxy line of devices, manufactured by Samsung; the HP Slate line of devices manufactured by Hewlett-Packard; and the Streak line of devices manufactured by Dell, Inc., of Round Rock, Tex.

In some embodiments, infrastructure in a system 100 may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers (including, e.g., blade servers executing virtual machines), databases, computing environments (including virtual machines, servers, and desktops), and applications. For example, an administrator of a machine 106a on a first network may use a remotely located data center to store servers 106b-n (including, for example, application servers, file servers, blade servers, databases, and backup servers), routers, switches, and telecommunications equipment. The data center may be owned and managed by the administrator of the machine 106a on the first network or a third-party service provider (including for example, a cloud services and hosting infrastructure provider) may provide access to a separate data center.

In some embodiments, a system in which users of a first network access at least a second network (including a pool of abstracted, scalable, and managed computing resources capable of hosting resources) may be referred to as a cloud computing environment. In other embodiments, resources may include, without limitation, virtualization technology, data center resources, applications, and management tools. In still other embodiments, Internet-based applications (which may be provided via a “software-as-a-service” model) may be referred to as cloud-based resources. In other embodiments, networks that provide users with computing resources, such as remote servers, virtual machines, or blades on blade servers, may be referred to as compute clouds or “infrastructure-as-a-service” providers. In still other embodiments, networks that provide storage resources, such as storage area networks, may be referred to as storage clouds. In further embodiments, a resource may be cached in a local network and stored in a cloud.

In some embodiments, some or all of a plurality of remote machines 106 may be leased or rented from third-party companies such as, by way of example and without limitation, Amazon Web Services LLC of Seattle, Wash.; Rackspace US, Inc. of San Antonio, Tex.; Microsoft Corporation of Redmond, Wash.; and Google Inc. of Mountain View, Calif. In other embodiments, all the hosts 106 are owned and managed by third-party companies including, without limitation, Amazon Web Services LLC, Rackspace US, Inc., Microsoft, and Google. Other providers of cloud-based resources may include, without limitation salesforce.com Inc. of San Francisco, Calif., and Facebook, Inc. of Menlo Park, Calif.

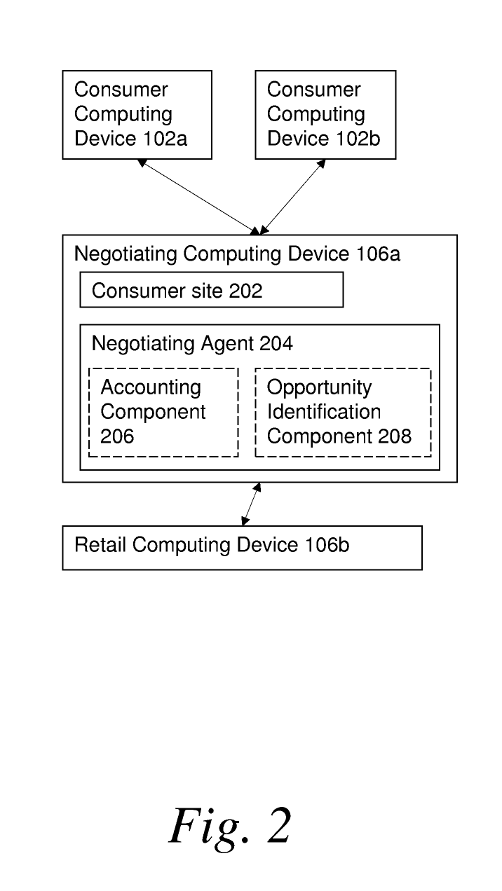

Referring now to FIG. 2, a block diagram depicts one embodiment of a system for identifying demand for, and negotiating discounted prices of, goods and services. The system includes consumer computing devices 102, a negotiating computing device 106a, a consumer site 202, a negotiating agent 204, and a retail computing device 106b. In brief overview, the computing devices 102 and 106 may be provided as computing device 100, 102, and 106 described above in connection with FIGS. 1A-1C.

Referring still to FIG. 2, and in greater detail, the consumer computing device 102 may execute software for accessing data provided by remote machines such as, by way of example, a web browser for viewing web pages hosted by the negotiating computing device 106a and the retail computing device 106b. Although a provider of a good or service is typically referred to herein as a retailer, it should be understood that such a provider is not limited to one who re-sells goods or products acquired in large quantities from manufacturers or wholesalers, as it may include other types of service providers, including those in professional services, direct sales vendors, and vendors of any type of good or service generally.

In one embodiment, the negotiating computing device 106a includes a consumer site 202 providing a user interface that allows users to, without limitation, create, view, and manage user accounts with the system, view item types available for purchase, indicate levels of interest in item types, and transfer funds to the negotiating computing device 106a. For example, the negotiating computing device 106a may include, or be in communication with, a web server as described above in connection with FIGS. 1A-1C.

The negotiating computing device 106a executes a negotiating agent 204. In one embodiment, the negotiating agent 204 reviews data received from a plurality of users to determine whether there is sufficient interest in an item of a particular type to commence negotiations for discounted pricing. In another embodiment, the negotiating agent 204 may communicate with the retail computing device 106b to negotiate a discounted price for an item. In yet another embodiment, the negotiating agent 204 may provide an indication of a level of demand to the retail computing device 106b. In some embodiments, the negotiating agent 204 executes a negotiation process to negotiate the price. In other embodiments, the negotiating agent 204 transmits a communication to human negotiators representing the retailers and the consumers, indicating that they should begin negotiations. The negotiating agent 204 makes an item having the type of good or service available for purchase by each of the plurality of users at the negotiated, discounted price.

The negotiating computing device 106a may include an accounting component 206, as depicted in shadow in FIG. 2. In some embodiments, the negotiating agent 204 executes the accounting component 206. The accounting component 206 may receive, from the consumer computing device 102, funding for use in purchasing a type of good or service. The accounting component 206 may also provide account details to the consumer computing device 102b. Alternatively, the accounting component 206 may receive, from the consumer computing device 102, an authorization to access an account maintained by a third party (e.g., a third-party bank) in which a user of the consumer computing device 102 stores funding for use in purchasing a type of good or service.

The negotiating computing device 106a may include an opportunity identification component 208, as depicted in shadow in FIG. 2. In some embodiments, the negotiating agent 204 executes the opportunity identification component 208. The opportunity identification component 208 may determine an identification of a level of interest in the type of good or service by a user of the second computing device, based on an amount of the funding. The opportunity identification component 208 may determine that a plurality of users has provided funding for use in purchasing items having the type of good or service. In some embodiments, the opportunity identification component 208 determines that a sufficient number of users have provided funding for purchasing items having a particular type and directs the negotiating agent 204 to begin the negotiation process. In other embodiments, and as will be discussed in greater detail below, the opportunity identification component 208 receives data from consumer computing devices 102a-n regarding types of goods or services consumers would be interested in purchasing but for which there are not currently negotiating opportunities.

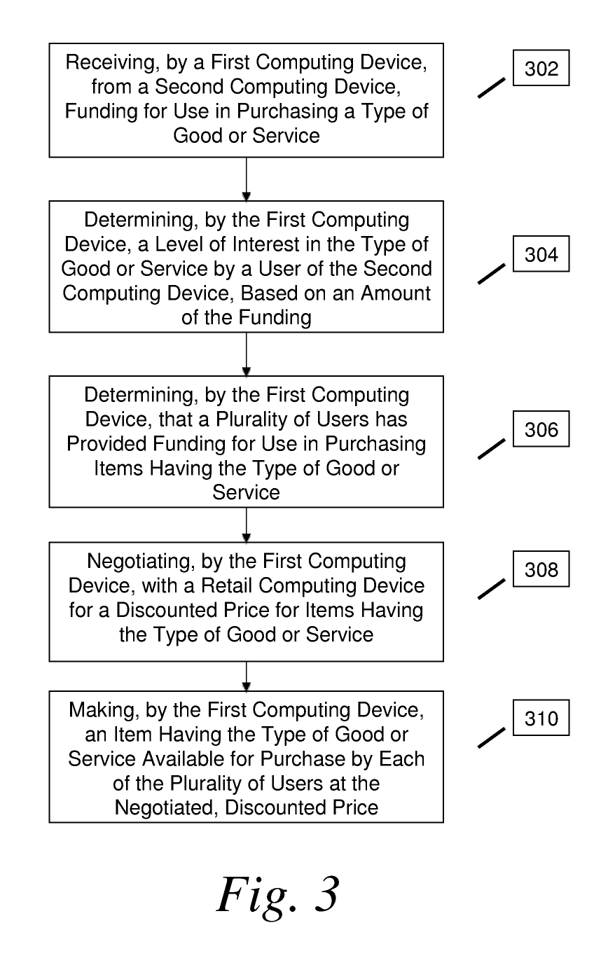

Referring now to FIG. 3, a flow diagram depicts one embodiment of a method for identifying demand for, and negotiating discounted prices of, goods and services. The method includes receiving, by a first computing device, from a second computing device, funding for use in purchasing a type of good or service (302). The method includes determining, by the first computing device, a level of interest in the type of good or service by a user of the second computing device, based on an amount of the funding (304). The method includes determining, by the first computing device, that a plurality of users has provided funding for use in purchasing items having the type of good or service (306). The method includes negotiating, by the first computing device, with a retail computing device for a discounted price for items having the type of good or service (308). The method includes making, by the first computing device, an item having the type of good or service available for purchase by each of the plurality of users at the negotiated, discounted price (310).

Referring now to FIG. 3, and in greater detail, the method includes receiving, by a first computing device, from a second computing device, funding for use in purchasing a type of good or service (302). In one embodiment, the negotiating computing device 106a generates a user interface with which a user of the consumer computing device 102a may transfer funding to the negotiating computing device 106a.

In another embodiment, the negotiating computing device 106a generates a user interface for display on the consumer computing device 102a, the user interface listing types of items for which the negotiating computing device 106a is able to negotiate discounted prices on behalf of a user of the consumer computing device 102a. For example, and in some embodiments, the negotiating computing device 106a hosts a consumer site 202, which is accessible by the user of the consumer computing device 102a for exchanging information with or transferring funds to the negotiating computing device 106a. In one embodiment, an item type includes a pre-defined category, such as, without limitation, automobiles, home improvement, dining, travel, health care, and leisure. In some embodiments, the negotiating computing device 106a receives profile information associated with the user of the consumer computing device 102a. For example, and without limitation, the profile information may include demographic information and geographic information. In one of these embodiments, the negotiating computing device 106a may use the profile information in determining which item types to display to the user as available for negotiation.

In one embodiment, to demonstrate not just interest but a level of commitment, the user of the consumer computing device 102a has the option of authorizing a transfer of funds to the negotiating computing device 106a. The user may have the option of determining how much funding to transfer. For example, the negotiating computing device 106a may receive sufficient funding to purchase a type of the good or service. As another example, a user of the consumer computing device 102a may establish an account with the negotiating computing device 106a and use the account as a savings account; in such an example, the negotiating computing device 106a may receive insufficient funding to purchase a type of the good or service. However, the user may provide funding via multiple transactions over a period of time, saving up funding until the user has provided a sufficient amount to purchase the type of good or service. In a further example, the user has the option of establishing multiple accounts, or of subdividing a single account, to categorize how much of a total amount of funding should be allocated to different purchases; for instance, a user may choose to allocate half of the available funds to the purchase of a new set of tires in the future and allocate the other half to the purchase of oil changes over a period of time. In another embodiment, instead of authorizing a transfer of funds to the negotiating computing device 106a, the user of the consumer computing device 102a may authorize the negotiating computing device 106a to access an account established with a third party. For example, the user of the consumer computing device 102a may establish an account (e.g., a savings account) with a bank or other third party, but authorize the bank to grant the negotiating computing device 106a access to account balances or other information. Regardless of whether the funding is stored in an account managed by the negotiating computing device 106a or by a third party, as consumers continue to allocate savings to various categories, retailers will have visibility into specific pools of purchasing power, assisting the retailers in assessing whether to run a promotion targeting the aggregated purchasing power in a pre-defined category and geography.

In other embodiments, instead of transferring currency (e.g., valid, traded currencies such as dollars, euros, yen, etc.), the user transfers points or artificial currency created by the first computing device for use in indicating a level of commitment. For example, and without limitation, users may be given a certain number of points on creating an account with the negotiating computing device 106a and may designate certain numbers of points to an item type to indicate how committed they are to completing a purchase of an item with the item type.

In some embodiments, by way of example and without limitation, a user does not provide funding—for example, the user may have indicated an interest in automotive goods and then specify how interested they are in making a purchase within a given period of time, without transferring any funding. In one of these embodiments, the negotiating computing device 106a analyzes the indication of interest to determine a level of commitment of the user to completing a purchase of an item with the item type. In other embodiments, the negotiating computing device 106a receives, from the consumer computing device 102, an identification of a level of interest by the user in an item type. For example, the user may respond to a “yes or no” question to indicate that he is or is not interested in an item type (e.g., “are you interested in automotive goods?”). As another example, the user may respond to a more granular listing of levels of interest (e.g., “rate on a scale of 1 to 10 a level of interest in an automotive good”) or more granularity in the type of item (e.g., tires vs. automotive goods in general). In other embodiments, the negotiating computing device 106a determines the level of interest indirectly.

The method includes determining, by the first computing device, a level of interest in the type of good or service by a user of the second computing device, based on an amount of the funding (304). In one embodiment, the negotiating computing device 106a determines the level of interest by analyzing how much and what type of funding the user of the consumer computing device 102b transferred to the negotiating computing device 106a. For example, the negotiating computing device 106a may determine that a first user that has transferred a number of points to an account designated for purchasing a type of good or service has a level of interest that is lower than a level of interest of a second user that has transferred a certain amount of a valid, traded currency to an account designated for purchasing the type of good or service—and that the second user has a level of interest that is lower than a level of interest of a third user who has transferred a larger amount of the valid, traded currency to an account designated for purchasing the type of good or service. As another example, retailers may view an aggregate amount representative of all funding allocated by all users interested in a particular type of good or service, as well as a number of users who have allocated such funding, and determine whether the aggregate amount is sufficient to interest the retailers in contacting the negotiating computing device 106a to offer a discounted rate to some or all of those users.

The negotiating computing device determines that a plurality of users has provided funding for use in purchasing items having the item type (306). The negotiating computing device 106a may determine to begin a negotiation process based upon a determination that a predetermined number of users have provided funding (e.g., a threshold set by an administrator, an amount specified by a retailer as a minimum number of users required to begin a negotiation process, or other predetermined number). In some embodiments, the negotiating computing device 106a determines a level of interest in the type of good or service by the plurality of users; for example, the negotiating computing device 106a may determine the level of interest by the plurality of users in a substantially similar manner as was described above in determining the level of interest for the user of the second computing device, based on the amount of the funding. In one embodiment, the negotiating computing device 106a determines to begin a negotiation process based upon a determination that the plurality of users have exceeded a threshold level of interest. In some embodiments, the negotiating computing device 106a determines that a plurality of users within a pre-defined geographic locale have provided funding. For example, the negotiating computing device 106a may determine that several users within a single zip code have provided funding and, based upon that determination, proceed to negotiating prices for those users; alternatively, in this example, if the users are in different zip codes, the negotiating computing device 106a may delay the negotiating process. In some embodiments, providing the ability to identify and negotiate on behalf of users within a geographic region provides a more targeted environment in which smaller geographic areas may participate in the online discounting movement, expanding the addressable market size.

In other embodiments, the negotiating computing device 106a receives an indication from a retail computing device 106b specifying a threshold number of users or a threshold amount of funding at which the retail computing device 106b is authorized to begin a negotiation process (which may be, for example and without limitation, simply alerting a human user of the retail computing device 106b that an opportunity exists, e.g., that the threshold number or amount has been reached). In further embodiments, the negotiating computing device 106a uses profile information associated with users to determine that a plurality of users has provided funding for use in purchasing items having the item type. For example, the negotiating computing device 106a may determine that a threshold number of users satisfying a specified profile requirement have provided funding (e.g., that a vendor-specified number of users having a particular characteristic, such as type of vehicle or mileage or medical history or purchasing history, have provided funding for items having the item type).

In some embodiments, the negotiating computing device 106a may enumerate a plurality of types of goods or services for which it is willing to begin negotiations and then determine that there are sufficient numbers of interested consumers to begin negotiating for a discounted price for a type of good or service. In other embodiments, the negotiating computing device 106a provides consumers with an option to indicate new types of goods or services for which there might be consumer interest at a subsequent point in time. For example, the negotiating computing device 106a may provide a user interface with which consumers may vote on new geographies or categories for which they would like to determine whether there is sufficient interest to begin negotiations. In such an example, the enumeration of the plurality of types of goods or services for which the negotiating computing device 106a is willing to negotiate is not exclusively generated by the negotiating computing device 106a (or by an administrator of the negotiating computing device 106a) but also incorporates consumer feedback. As a further example, the user interface with which consumers can vote may specify particular geographies or categories, or allow consumers to submit geographies or categories; the user interface may also specify a threshold number of consumers needed in order to add a particular geography or category to the enumeration of available areas or categories.

The negotiating computing device negotiates with a retail computing device 106b for a discounted price for items having the type of good or service (308). In one embodiment, the negotiating computing device 106a begins an automated negotiation process with the retail computing device 106b. In another embodiment, the negotiation computing device 106a indicates to a first human that a sufficient number of users have indicated a sufficiently high level of interest for the first human to begin a negotiation process with a second human associated with the retail computing device 106b, or with the retail computing device 106b; for example, the negotiating computing device 106a may provide an indication of a level of demand to a human negotiator with a recommendation to begin negotiating with a human associated with the retail computing device. In still another embodiment, the negotiation computing device 106a provides an indication of a level of demand to the retail computing device 106b. In yet another embodiment, the negotiation process simply involves alerting the retail computing device 106b to an opportunity to reach the plurality of users who have demonstrated a particular level of interest and to offer the interested users a discounted rate.

In some embodiments, the negotiation includes negotiating a base rate and a variable fee rate, the variable fee rate adjusted based on a number of the plurality of users. For example, the negotiation may include specifying that a vendor will receive a base fee for extending a discounted price to a minimum number of consumers, as well as an additional fee that will vary (e.g., increase or decrease) based on a number of consumers above the minimum number who purchase an item at the discounted price.

In other embodiments, the negotiation includes negotiating a barter or trade agreement. For example, the negotiation may include specifying that a vendor will provide a good or service in exchange for a good or service provided by each of the plurality of users.

The negotiating computing device 106a makes an item having the type of good or service available for purchase by each of the plurality of users at the negotiated, discounted price (310). In some embodiments, the negotiating computing device 106a makes a purchase of the goods or services at the discounted price on behalf of the plurality of users. In one of these embodiments, the negotiating computing device 106a transmits a notification to each of the plurality of users that the purchase has been completed; for example, the negotiating computing device 106a may make a plurality of purchases with funding from each of the plurality of users' accounts. As another example, the negotiating computing device 106a may aggregate the funding from the plurality of users' accounts into a single account and make a single purchase for a plurality of items. In another of these embodiments, the negotiating computing device 106a provides each of the plurality of users with a receipt that the user may show to a retailer to collect the good or service purchased on their behalf by the negotiating computing device 106a.

In other embodiments, the negotiating computing device 106a negotiates a discounted price on behalf of the plurality of users but does not complete the purchase. In one of these embodiments, the negotiating computing device 106a indicates to each of the plurality of users that he or she may contact the retail computing device 106b, or an entity associated with the retail computing device 106b, to make a purchase of the good or service at the discounted rate; for example, the negotiating computing device 106a may provide, for each of the plurality of users, a discount code for use in purchasing the good or service at the negotiated, discounted price.

In one embodiment, the negotiating agent 204 may analyze a type and quantity of funding provided by a user of the consumer computing device 102 and provide the user with feedback. For example, the negotiating agent 204 may recommend a type of good or service potentially of interest to the user. As another example, the negotiating agent 204 may recommend an alternative allocation of funds amongst different types of goods or services.

In one embodiment, the negotiating computing device 106a receives, from the consumer computing device 102, an identification of a user characteristic; for example, the negotiating computing device 106a may receive an identification of an age, preference, medical condition, risk factor, or purchase history. User characteristics may vary depending on the type of good or service in which the user has an interest; for example, for a user interested in health care products and services, characteristics may include medical conditions, family history, age, level of exercise, nutritional intake data, weight, and level of attention to preventive medical care. User characteristics may be provided as part of the profile information described above or separately. As another example, for a user interested in automotive products, user characteristics may include a level of risk involved in delaying service to a vehicle or a level of risk that the user will be injured, while for a user interested in housing-related products and services, user characteristics may include a level of risk of expense or injury arising from delaying maintenance of a property. In another embodiment, the negotiating computing device 106a transmits a recommendation for at least one item having the item type, based upon the identification of the user characteristic and an amount of the received funding. By way of example, the user characteristic may indicate that the user of the consumer computing device 102b owns an older model car that consistently requires service of a particular part; the negotiating computing device 106a may transmit a recommendation for a replacement part. As another example, the user characteristic may indicate that the user is at risk for heart attacks and the negotiating computing device 106a may transmit a recommendation for a visit with a cardiologist. In further examples, such as where the user of the consumer computing device 102 has established a health savings account, the negotiating computing device 106a may analyze indications of user characteristics to determine user risk factors and recommend particular products (e.g., medical devices) or services to the user based on the analysis and the amount of funding in the account.

In some embodiments, the negotiating computing device 106a transmits, to the consumer computing device 102, a recommendation for an allocation of the received funding, based upon the identification of the user characteristic and an amount of the received funding. By way of example, the user characteristic may indicate that the user of the consumer computing device 102b owns an older model car that consistently requires service of a particular part but the user has allocated funding to purchasing a different part that is still under warranty and less likely to require replacement; the negotiating computing device 106a may transmit a recommendation that the user optimize the funding allocations to increase the amount of funding available for purchasing the part more likely to require service and not under warranty. In further examples, such as where the user of the consumer computing device 102 has established a health savings account, the negotiating computing device 106a may analyze indications of user characteristics to determine user risk factors and recommend an optimization of funding allocations to increase the amount of funding available for particular products (e.g., medical devices) or services to the user based on the analysis and the amount of funding in the account. For example, the user may specify that a certain amount of funding should go to a health savings account and request that the negotiating computing device 106a determine an optimized allocation of the amount of funding that should go to various sub-accounts. The negotiating computing device 106a may consider various factors in generating an allocation recommendation including, but not limited to, immediate risk factors, family history, and the net present value of the expected level of savings to the consumer for having taken proactive steps towards preventative care or maintenance. The negotiating computing device 106a may analyze other factors in addition to the amount of funding and identified user characteristics, including, without limitation, feedback from the current user, previous users, and vendors. For example, the negotiating computing device 106a may analyze factors including a degree of importance the user has assigned to particular sub-categories; for instance, a user interested in event-planning related goods and services may have specified a level of importance for a particular sub-category such as venue or menu options, or other users who have previously purchased event-planning related goods and services may have specified the level of importance, and the negotiating computing device 106a may optimize an allocation of funding based at least in part on the specified levels of importance.

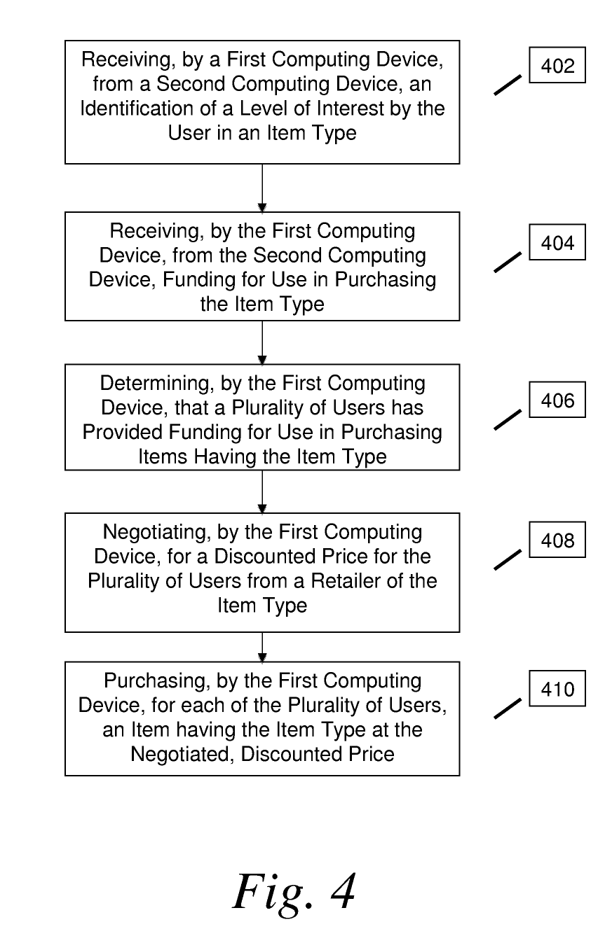

Referring now to FIG. 4, a flow diagram depicts one embodiment of a method for identifying demand for, and negotiating discounted prices of, goods and services. The method includes receiving, by a first computing device, from a user of a second computing device, an identification of a level of interest by the user in an item type (402). The method includes receiving, by the first computing device, from the second computing device, funding for use in purchasing the item type (404). The method includes determining, by the first computing device, that a plurality of users has provided funding for use in purchasing items having the item type (406). The method includes negotiating, by the first computing device, for a discounted price for the plurality of users from a retailer of the item type (408). The method includes purchasing, by the first computing device, for each of the plurality of users, an item having the item type at the negotiated, discounted price (410).

Referring now to FIG. 4, and in greater detail, the first computing device 106a receives, from a user of a second computing device, an identification of a level of interest by the user in an item type (402). In one embodiment, the negotiating computing device 106a receives the identification of the level of interest as described above in connection with FIG. 3.

The first computing device receives, from the second computing device, funding for use in purchasing the item type (404). In one embodiment, the negotiating computing device 106a receives the funding as described above in connection with FIG. 3.

The first computing device determines that a plurality of users has provided funding for use in purchasing items having the item type (406). In one embodiment, the negotiating computing device 106a determines that the plurality of users have provided funding as described above in connection with FIG. 3.

The first computing device negotiates for a discounted price for the plurality of users from a retailer of the item type (408). In one embodiment, the negotiating computing device 106a negotiates as described above in connection with FIG. 3.

The first computing device purchases, for each of the plurality of users, an item having the item type at the negotiated, discounted price (410). In some embodiments, the negotiating computing device 106a purchases the item as described above in connection with FIG. 3.

In one embodiment, the methods and systems described herein may be considered analogous to a savings account for consumers who know about a future purchase they need to make and are seeking a discount price. In another embodiment, the relevance of the deals being offered to consumers is much higher than in conventional systems since in this embodiment the first computing device 106 can consider user-specified demand for purchases within a category of items.

In one example, a user selects a category of interest (e.g., automotive, leisure, food, or home improvement) and, optionally, provides additional details regarding the level of interest, such as how far she is willing to travel for a good or service in the category, a time period during which she is likely to be interested in the category, and other data to improve the system's ability to identify relevant deals. In this example, the user may choose to share the data with other users so as to encourage other users to provide information regarding categories of interest, increasing the likelihood that the threshold for committed users is met.

In one example, a user who needs to purchase new tires may transfer sufficient funds to the first computer 106a to cover the purchase of new tires with an instruction to use the funds only when a price for the new tires is negotiated to be below a pre-defined threshold. In this example, when sufficient users have transferred funds for the purchase of new tires, the first computer 106a contacts the second computer 106b and negotiates for a discounted price, such as a price below the pre-defined threshold. In this example, the first computer 106a determines a level of interest and commitment based upon the willingness of each of the plurality of users to transfer the funding for the purchase. In another example, the user allocates funds to an existing deal offered to the user.

It should be understood that the systems described above may provide multiple ones of any or each of those components and these components may be provided on either a standalone machine or, in some embodiments, on multiple machines in a distributed system.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, and hardware (e.g., integrated circuit chips; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for identifying demand for and negotiating discounted prices of goods and services, it will now become apparent to one of skill in the art that other embodiments incorporating the concepts of the disclosure may be used. Therefore, the disclosure should not be limited to certain embodiments, but rather should be limited only by the spirit and scope of the following claims.

1. A computer-implemented method comprising:
receiving, by a first computing device, from a second computing device, funding for use in purchasing a type of good or service;
determining, by the first computing device, a level of interest in the type of good or service by a user of the second computing device, based on an amount of the funding;
determining, by the first computing device, that a plurality of users has provided funding for use in purchasing items having the type of good or service;
negotiating, by the first computing device, with a retail computing device for a discounted price for items having the type of good or service; and
making, by the first computing device, an item having the type of good or service available for purchase by each of the plurality of users at the negotiated, discounted price.

2. The computer-implemented method of claim 1 further comprising receiving, by the first computing device, from the second computing device, an identification of a user characteristic.

3. The computer-implemented method of claim 2 further comprising transmitting, by the first computing device, a recommendation for an item having the item type, based upon the identification of the user characteristic and an amount of the received funding.

4. The computer-implemented method of claim 2 further comprising transmitting, by the first computing device, a recommendation for an allocation of the received funding, based upon the identification of the user characteristic and an amount of the received funding.

5. The computer-implemented method of claim 1, wherein making an item available further comprises purchasing, by the first computing device, for at least one of the plurality of users, the item at the negotiated, discounted price.

6. The computer-implemented method of claim 1, wherein making an item available further comprises providing, by the first computing device, for each of the plurality of users, a discount code for use in purchasing the item having the type of good or service at the negotiated, discounted price.

7. The computer-implemented method of claim 1, wherein receiving further comprises receiving sufficient funding to purchase a type of the good or service.

8. The computer-implemented method of claim 1, wherein receiving further comprises receiving an amount of funding insufficient to purchase a type of the good or service.

9. The computer-implemented method of claim 1, wherein receiving further comprises receiving an amount of an artificial currency.

10. The computer-implemented method of claim 1, wherein determining a level of interest further comprises receiving, by the first computing device, from the second computing device, a level of interest in the type of good or service by the user of the second computing device.

11. The computer-implemented method of claim 1, wherein determining that the plurality of users has provided funding further comprises determining, by the first computing device, that a plurality of users within a specified geographic locale has provided funding for use in purchasing items having the type of good or service.

12. The computer-implemented method of claim 1, wherein negotiating further comprises negotiating a base rate and a variable fee rate, the variable fee rate adjusted based on a number of the plurality of users.

13. The computer-implemented method of claim 1, wherein negotiating comprises providing an indication of a level of demand to the retail computing device.

14. The computer-implemented method of claim 1, wherein negotiating comprises providing an indication of a level of demand to a human negotiator with a recommendation to begin negotiating with a human associated with the retail computing device

15. A computer-readable medium comprising computer-readable instructions tangibly stored on the computer-readable medium, wherein the instructions are executable by at least one computer processor to execute a method, the computer-readable medium comprising:
instructions to receive, by a first computing device, from a second computing device, funding for use in purchasing a type of good or service;
instructions to determine, by the first computing device, an identification of a level of interest in the type of good or service by a user of the second computing device, based on an amount of the funding;
instructions to determine, by the first computing device, that a plurality of users has provided funding for use in purchasing items having the type of good or service;
instructions to negotiate, by the first computing device, with a retail computing device for a discounted price for items having the type of good or service; and
instructions to make, by the first computing device, an item having the type of good or service available for purchase by each of the plurality of users at the negotiated, discounted price.

16. The computer-readable medium of claim 15 further comprising instructions to receive, by the first computing device, from the second computing device, an identification of a user characteristic.

17. The computer-readable medium of claim 16 further comprising instructions to transmit, by the first computing device, a recommendation for an item having the item type, based upon the identification of the user characteristic and an amount of the received funding.

18. The computer-readable medium of claim 16 further comprising instructions to transmit, by the first computing device, a recommendation for an allocation of the received funding, based upon the identification of the user characteristic and an amount of the received funding.

19. The computer-readable medium of claim 15, wherein instructions to receive further comprise instructions to receive an amount of funding insufficient to purchase a type of the good or service.

20. The computer-readable medium of claim 15, wherein instructions to receive further comprise instructions to receive an amount of an artificial currency.

21. The computer-readable medium of claim 15, wherein instructions to make an item available further comprise instructions to purchase, by the first computing device, for at least one of the plurality of users, the item at the negotiated, discounted price.

22. The computer-readable medium of claim 15, wherein instructions to make an item available further comprise instructions to provide, by the first computing device, for each of the plurality of users, a discount code for use in purchasing the item having the type of good or service at the negotiated, discounted price.

23. A system comprising:
an accounting component executing on a first computing device and receiving from a second computing device funding for use in purchasing a type of good or service;
an opportunity identification component (i) executing on the first computing device, (ii) determining an identification of a level of interest in the type of good or service by a user of the second computing device, based on an amount of the funding, and (iii) determining that a plurality of users has provided funding for use in purchasing items having the type of good or service; and
a negotiation component (i) executing on the first computing device, (ii) negotiating with a retail computing device for a discounted price for items having the type of good or service and (iii) making an item having the type of good or service available for purchase by each of the plurality of users at the negotiated, discounted price.
